(19) United States
(12) Patent Application Publication
(10) Pub. No.: US 2004/0068514 A1
(43) Pub. Date: Apr. 8, 2004

(54) System and method for biotechnology information access and data analysis

(76) Inventors: Parvathi Chundi, Cupertino, CA (US); Patricia Collins, Mountain View, CA (US); Simon Graham, Palo Alto, CA (US); Aditya Vailaya, Santa Clara, CA (US)

Correspondence Address: AGILENT TECHNOLOGIES, INC., INTELLECTUAL PROPERTY ADMINISTRATION, LEGAL DEPT., P.O. BOX 7599, M/S DL429, LOVELAND, CO, 80537-0599, US

(21) Appl. No.: 10/264,598

(22) Filed: Oct. 4, 2002

(51) Int. Cl. G06F 7/00

(52) U.S. Cl. 707/102

(57) ABSTRACT

Systems and methods for database searching and data analysis with simultaneous, unified access to multiple heterogeneous data sources with effective reuse of user search session information for data analysis. The systems comprise a data source containing at least a partial copy of at least two public databases, at least one search program module operatively coupled to the data source and configured to carry out a search of the databases in the data source according to a user query, a data mining module operatively coupled to the data source and configured to provide for clustering of search results or documents from the user query and a user interface program module operatively coupled to the search program module and the data mining module, the user interface program module configured provide a visual interface for creating the user query and viewing the search results.

### BACKGROUND OF THE INVENTION

Recent advances in biological experimental techniques, such as high speed DNA sequencing, nucleic acid microarrays and robotic high-throughput screening, have created a flood of useful data. The increasing amounts of information threaten to overwhelm the ability of individual scientists to understand and analyze available data. Large data streams that have recently become available include complete genome sequence information, gene expression patterns, proteomics information, protein-protein interaction data, single nucleotide polymorphisms (SNPs), and pathway and high-throughput screening data. The Genbank database, for example, contains more than 13 billion bases from over 100,000 species. The number of nucleotide bases available in public databases is doubling about every fourteen months, and this rate of increase will likely grow.

Understanding diseases and disease mechanisms and identifying new drugs present complex, labor intensive tasks that require analysis of large quantities of data that is often scattered throughout multiple, heterogeneous databases. The heterogeneous databases frequently have different search interface configurations and different semantics or ontology, and thorough searching of all relevant databases can be very difficult and time consuming. Scientists must use a variety of search techniques to adequately investigate all of the relevant databases. The different natures of bioninformatics databases and the difficulty in performing thorough searches greatly increase the risk that pertinent data will be missed or omitted.

Systems have been developed to facilitate searching of multiple heterogeneous databases. For example, the SRS system (http://srs.ebi.ac.uk/), provides access to structured versions of several public databases. DiscoveryLink™ (http://ibm.com/software/webservers/lifesciences/discovery.html), which is provided by Netgenics and IBM, and Commerce One's iMerge™ (http://www.commerceone.com) similarly provide a unified view of selected public databases. Genecards (http://www.dkfz-heidelberg.de/GeneCards) provides a unified gene-centric view of selected databases. NCBI's Entrez (http://www.ncbi.nlm.nih.gov/Database/index.html), DBget (http://www.genome.adjp/dbget/dbget.links.html), and Bionavigator (http://www.bionavigator.com) provide unified access to multiple databases. Doubletwist (http://www.doubletwist.com) provides free-text and structured searches of selected DNA and peptide sequence databases.

The aforementioned database search systems are deficient in various respects that present difficulties to biotechnology researchers. Many of the search systems that provide or attempt to provide unified or single point access to multiple databases still require separate, sequential searching of each of the multiple databases. The search systems typically provide no support for exploration of large amounts of data, and it is not clear that currently existing search systems are scalable to accommodate the large database sizes that are increasingly common in molecular biology. There is no provision made for integration of the search environment with data analysis environments. Particularly, no currently available search systems provide effective support for re-use of data, search results, and analysis procedures across multiple user sessions or for multiple users. Increasingly, multiple researchers are involved in coordinated search efforts, and the inability of search systems to provide for reuse of data, results and procedures across groups and user sessions can result in redundant searches and/or incomplete searches.

There is accordingly a need for a search system for biotechnology databases that provides unified access to multiple heterogeneous data sources, that supports reuse of search actions and results across multiple users and multiple sessions, that provides a scalable framework for using increasingly large databases, and which facilitates information access and data analysis for biotechnology researchers. The present invention satisfies these needs, as well as others, and overcomes the deficiencies found in the background art.

Relevant Literature

U.S. Patent documents of interest include U.S. Pat. Nos. 5,978,799, 5,694,593, 5,799,301, 6,298,343, 6,321,224, 6,289,338, 6,275,820, 6,067,552, 5,924,090, 6,085,186, and 6,102,969, the disclosures of which are incorporated herein by reference.

### SUMMARY OF THE INVENTION

The invention provides systems and methods for database searching and data analysis with unified access to multiple heterogeneous data sources with effective reuse of user search session information for data analysis. The systems of the invention comprise, in general terms, a data store source containing at least a partial copy of at least two public databases, at least one search program module operatively coupled to the data source and configured to carry out a search of the databases in the data source according to a user query, a data mining module operatively coupled to the data source and configured to provide for clustering of search results or documents from the user query and a user interface program module operatively coupled to the search program module and the data mining module, the user interface program module configured provide a visual interface for creating the user query and viewing the search results.

The systems may further comprise a reuse program module operatively coupled to the search program module, the data mining module and the user interface program module, with the reuse module configured to store user action information in a user data source. The systems may additionally comprise a request broker program element operatively coupled to the search program module, the data mining module and the user interface program module, and configured to direct at least a portion of/the user query to the search program module. The search program molecule may comprise a keyword search program module, a structured query search program module, and/or an ontology mapping program module, which is configured to search the data source according to annotation of a selectable ontology. In certain embodiments the systems may comprise a flexible automation program module configured to allow users to define re-usable search scripts. The user interface module may be configured to recognize repetitions of user tasks and provide predictions, based on the repetitions, to a user via the visual interface.

In certain embodiments, the data mining module is further configured to identify search results or documents according to a selected reference. The data mining module may also be configured to form clusters of related search results or documents according to an unsupervised clustering procedure, and may be is capable of preparing a single list of all search results or documents retrieved independently of the unsupervised clustering procedure. The data mining module may further be configured to assign a relevance score to the search results or documents based upon a frequency of terms from the query that appear within each of the search result.

The unsupervised clustering procedure performed by the data mining module may employ a group-average-linkage technique to determine relative distances between the search results or documents. The group-average-linkage technique employs an algorithm for determining a proximity score that defines relative distances between the search results, the algorithm comprising

S₁j=2×(½−N(T₁, Tⱼ)/(N(Tᵢ)+N(Tⱼ))

wherein T₁ is a term in a search result I, Tⱼ is a term in a search result j, N(T₁,Tⱼ) is the number of co-occurring terms that the search results i and j have in common, N(T₁) is the number of terms in search result I, and N(Tⱼ) is the number of terms in search result J.

The methods of the invention comprise, in general terms, providing a data store containing at least partial copies of at least two public databases, formulating a query by a user, submitting the query uniformly to each database in the data store, fetching search results or documents based on the query, and forming clusters of related search results or documents by a data mining module according to an unsupervised clustering procedure. The methods may further comprise displaying the clusters of related search results on a user interface and/or storing the clusters of related search results in a user data store. The methods may additionally comprise storing at least one user action, associated with submitting of the query, in the user data store. In certain embodiments, the methods may comprise defining a reusable query script and storing the query script in the user data store, and identifying repetitive user actions and storing the repetitive user actions in the user data store.

In some embodiments of the invention, the methods may comprise identifying search results by the data mining module according to a selected reference. The methods may additionally include preparing, by the data mining module, a single list of all search results or documents independently of the unsupervised clustering procedure, and assigning a relevance score, by the data mining module, to the search results based upon a frequency of terms from the query that appear within each of the search result. In certain embodiments, the forming of the clusters of search results may comprise employing, by the data mining module, a group-average-linkage technique to determine relative distances between the search results. Employing the group-average-linkage technique may comprise employing the above algorithm for determining a proximity score that defines relative distances between the search results.

These and other objects, advantages, and features of the invention will become apparent to those persons skilled in the art upon reading the details of the invention as more fully described below.

### BRIEF DESCRIPTION OF THE DRAWINGS

A more complete understanding of the systems and methods of the invention may be obtained by referring to the following detailed description together with the accompanying drawings, which are for illustrative purposes only.

FIG. 1 is a functional block diagram showing a high level architecture for a system for information access and data analysis in accordance with the invention.

FIG. 2 is a functional block diagram of a networked computer system that may be used with the system for information access and data analysis of the invention.

FIG. 3 is a functional block diagram of a specific embodiment of the system for information access and data analysis of FIG. 1.

### DETAILED DESCRIPTION OF THE INVENTION

Disclosed herein are systems and methods for database searching and data analysis with simultaneous, unified access to multiple heterogeneous data sources with effective reuse of user search session information for data analysis. The invention provides for reuse of previous user query actions and results, supports automation of repetitive search tasks, provides unobtrusive inferences from repetitive tasks to predict elidable tasks, and provides sophisticated session management for collaboration between multiple users.

Before the subject invention is described further, it should be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

It should also be noted that as used herein and in the appended claims, the singular forms “a”, “and”, and “the” include plural referents unless the context clearly dictates otherwise. Thus, for example, reference to “a module” includes a plurality of such module, and reference to “the query” includes reference to one or more queries and equivalents thereof known to those skilled in the art, and so forth.

The publications discussed herein, including Internet-based publications, are provided solely for their disclosure prior to the filing date of the present application. Nothing herein is to be construed as an admission that the present invention is not entitled to antedate such publication by virtue of prior invention. The dates of publication provided may be different from the actual publication dates, which may need to be independently confirmed. All publications mentioned herein are incorporated herein by reference to disclose and describe the methods, systems or other subject matter in connection with which the publications are cited.

Any definitions herein are provided for reason of clarity, and should not be considered as limiting. The technical and scientific terms used herein are intended to have the same meaning as commonly understood by one of ordinary skill in the art to which the invention pertains.

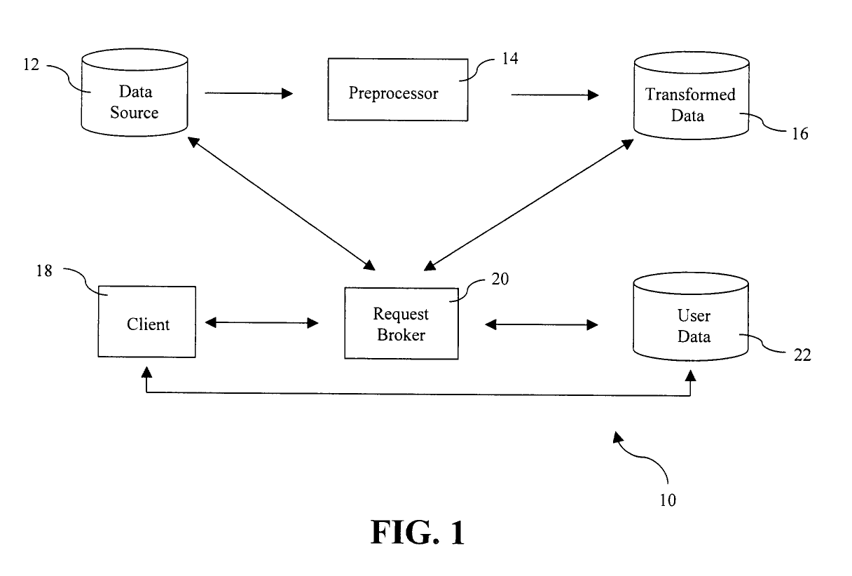

With the above in mind, reference is made more specifically to the drawings in which, for illustrative purposes, show the present invention embodied in systems and methods in FIG. 1 through FIG. 3. It will be appreciated that the systems may vary as to configuration and as to details of the parts, and that the methods may vary as to detail and the order of the events or acts, without departing from the basic concepts as disclosed herein. The invention is described primarily in terms of use with biotechnology databases. The invention may, however, be used in association with databases associated with any types of technologies, as will be readily apparent to those skilled in the art. It will also be apparent that various functional components of the invention as described herein may share the same logic and be implemented within the same program elements, or in different program elements and configurations.

The systems for information access and data analysis of the invention provide easy, simultaneous, unified access to multiple heterogeneous databases. The subject systems are well suited for use by scientific researchers and research groups, including, for example, chemistry, biotechnology, material science, semiconductor, and aerospace researchers. Researchers can automate their work with the inventive systems without requiring the services of an information technology specialist. Keyword and structure query search features are provided by the systems over a unified view of the heterogeneous databases. A data mining search feature may also be used, with an extensible framework to facilitate the use of multiple KDD (knowledge discovery in databases) algorithms to capture multiple different kinds of relevance in searches. In certain embodiments, searches based on ontology mapping are provided for selectable hierarchical structuring and subcategorising of data source information.

The systems also provide support for reuse of user actions and results from search sessions and data mining algorithms by treating such user actions as first class objects that can be manipulated as icons via the user interface. The systems support automation of repetitive tasks during search sessions by providing automatic and unobtrusive inference, and provide sophisticated user session management for collaboration of multiple researchers and reuse of search actions by multiple researchers.

Referring now to FIG. 1, there is shown an overview of a system 10 for information access and data analysis in accordance with the invention. The system 10 includes a data source 12 containing information in the form of copies or partial copies of various databases which may comprise, for example, public and/or proprietary databases of scientific information and publications. Preprocessor 14, which may comprise one or more program software modules capable of carrying out search operations and data mining operations as described below, computes ancillary data 16 from information in data source 12 according to user queries or user actions from client 18. The transformed data 16 includes search results responsive to the user queries, which are provided back to client 18. A requests broker 22 manages the programming or software aspects of system 10 involved in creating user queries and responsive search results, which in many embodiments are distributed amongst multiple networked computers, as also described below. The Request broker 22 determines which parts of user query are to be directed to specific search modules, data mining module, or to other modules associated with preprocessor 14. User actions, interactions, and search results that arise during search sessions from transformed data 16 and action by client 18 may be stored in a user data store 20 for subsequent reuse.

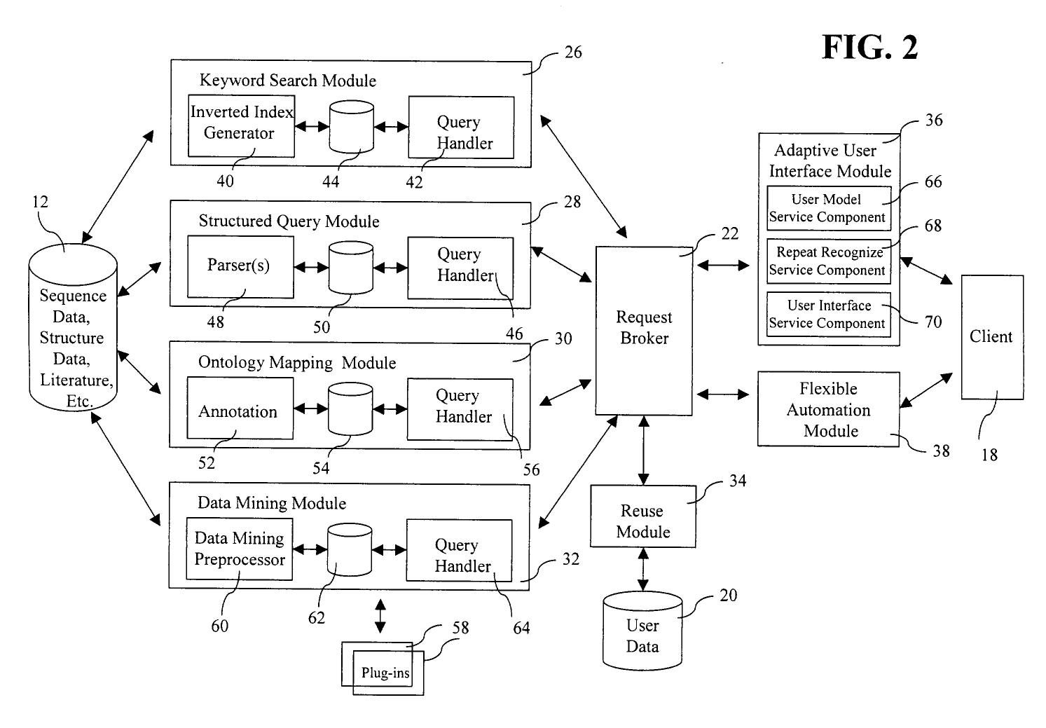

A variety of system architectures may be used to implement the features described above. Referring to FIG. 2, there is shown a detailed view of one embodiment of a system 24 for information access and data analysis, wherein like reference numbers are used to denote like parts. The system 24 comprises a keyword search module 26, a structured query search module 28, an ontology mapping module 30, and a data mining module 32, each of which are operatively coupled to or otherwise interfaced with data store 12 and request broker 22. In the system 24, user data store 20 is operatively coupled to or interfaced with request broker 22 via a reuse module 34. A user interface module 36, which may be adaptive, is operatively coupled to or interfaced with request broker 22 and client 18. A flexible automation module 38 is also operatively coupled to or interfaced with request broker 22 and client 18.

Data source 12 may include copies or partial copies of various scientific and technical databases. In the embodiment of FIG. 2, data source 12 includes databases with nucleic acid and protein sequence data or information, databases containing nucleic acid and protein structural information, scientific literature or textual databases, and other like databases, which may be centralized or distributed amongst several computers (not shown). The databases in data store will typically comprise two or more public biotechnology databases. Numerous public biotechnology databases are available and may be present as copies or partial copies in data store 12. Some exemplary genomic databases include, by way of example, European Molecular Biology Laboratory Nucleotide Sequence Data Library (EMBL), http://www.embl-heidelberg.de/, DNA Database of Japan (DDBJ), http://www.ddbj.nig.acjp/, Genbank, http://www. ncbi.nlm.nih.gov/Genbank/GenbankSearch.html, Swiss-Prot., http://www.expasy.ch/ sprot/sprot-top.html, Genome Database (GDB), http://gdbwww.gdb.org, Online Mendelian Inheritance in Man (OMIM), http://www3.ncbi.nlm.nih.gov/Omim/, Cellular Response Database, http://LHI5.umbc.edu/crd, dbEST, http://www.ncbi.nlm.nih. gov/dbEST/index.html, GeneCards, http://bioinformatics.weizmann.ac.il/cards/, Globin Gene Server, http://globin.cse.psu.edu, Human Developmental Anatomy, http://www.ana.ed.ac.uk/anatomy/database/humat/, Kidney Development Database, http://www.ana.ed.ac.uk/anatomy/database/kidbase/kidhome.html, Merck Gene Index, http://www.merck.com/mrl/merck_gene_index.2.html, and Tooth Gene Expression Database, http://bite-it.helsinki.fi/. Public literature databases include, for example, GenBank (http://www.ncbi.nlm.nih.gov/Genbank/), Medline (http://medline.cos.com/) and PubMed (http://www.ncbi.nlm.nih.gov./entrez/), Various other public-accessible databases are known to those skilled in the art and may also be present as copies or partial copies in data source 12.

Various aspects of individual databases in data store 12 may be searchable as database subsections. Subsections may comprise, for example, recent updates or portions of a database selectable by date. In this manner, a user can search a specific “update” subsection of a database that includes new or recent subject matter without performing a redundant search on previously searched portions of a database that were available during earlier search sessions. Data source 12 may be arranged as a set of files. There may be a single large file for each database in source 12, or multiple files with one file for each record. Each program module converts the data into a representation amenable to its processing as required.

Keyword search module 26 preprocesses data from data source 12 and transforms it into a form suitable for computing relevant items responsive to user queries. User keyword search queries, in many embodiments, may comprise a simple list or lists of keywords, with conventional information retrieval algorithms used to index data via creation of an inverted index by inverted index generator 40. Inverted index generator 40 may utilize a sequence of (key, pointer) pairs wherein each pointer points to a record in data store 12 which contains the key value in some particular field. The index may be sorted on the key values to allow rapid searching for a particular key value. Indices may contain gaps to allow for new entries to be added in a selected sort order without requiring shifting of subsequent entries. In some embodiments, records within data store 12 may be searched based on more than one field, and multiple indices may be created that are sorted on those corresponding keys.

Keyword search module 26 also includes a query handler program element 42 that interacts with request broker 22 and handles the creation and modification of user queries and responsive search results, which are shown collectively as search data 44. Query handler 42 receives keyword based user queries from request broker 22 and passes them to inverted index generator 40. Query handler 42 also passes search results responsive to keyword-based queries back to request broker. Query handler 42 may keep track of or otherwise monitor and keep records of all keyword-based queries and search results for use by reuse module 34. Tracking of queries and search results may involve labeling of queries and query results from search data 44 with query ID numbers or codes for subsequent handling by reuse module 34 and presentation to users by user interface module 36 as described below.

The structured query module 28 provides for extraction of structured information, such as author names, publication dates, and sequence records, from data store 12 according to user queries. Structured query module 28 includes a query handler element 46 that interacts with request broker 22 and handles the creation and modification of structured queries and corresponding search results. Query handler 46 may monitor or track structured query results for reuse by users. Structured query module 28 also includes one or more parser program elements 48, which may be specific for individual databases within data source 12, and which are used to determine syntactic structure of symbols associated with user queries. The output from parser 48, which may be in the form of an abstract syntax tree, is shown as search data 50.

Ontology mapping module 30 provides for searching of data source 12 based on one or more selectable ontologies or hierarchical arrangements of subject topics and subtopics in an “inverted tree” arrangement. Ontology mapping module 30 includes an annotator program element 52 that provides transformed or search data 54 from data source 12 according to selected search ontologies via hierarchical parsing or other annotation function. Ontologies may be structured according to “parent”-“child” relationships of attribute-value pairs as described in U.S. Pat. No. 6,289,338. Ontology mapping module includes a query handler element 56 that interacts with request broker 22 and handles ontology-based queries and search results, and monitoring or tracking of ontology-based query results. An ontology may specify, for each topic, a set of rules describing membership in that topic. The membership rules are used to determine if, for example a GenBank entry or a Medline document belongs to a topic. Ontology mapping module 30 provides means for querying within specific topics, thereby reducing the search space, and also for grouping large results into meaningful categories.

The data mining module 32 provides for searches of data source 12 using data mining algorithms appropriate for handling large query results and extracting knowledge from data. Data mining module 32 may be extensible to accommodate user selectable plug-in modules 58. Data mining module 32 includes a preprocessor 60 for generating transformed data 62 from data source 12 according to data mining algorithms internal to preprocessor 60 and/or obtained from plug-ins 58.

The data mining module 32 forms clusters of related search or query results according to an unsupervised clustering procedure and displays the clusters of related search results on the user interface.

The data mining module 32 is further capable of preparing a single list of all search results retrieved as raw data, independently of the unsupervised clustering procedure, after eliminating results not reachable via the web. The data mining module 32 assigns simple relevance scores to the search results based upon a frequency of terms from the query that appear within each document. The search results are then listed in the single list in an order ranging from a highest to lowest simple relevance scores.

Customized stop word lists may be provided by the data mining module 32 which are tailored to individual or groups of generic, web-based search engines, publication sites and sequences sites. The customized stop word lists may be manually provided, such as by providing predefined customized stop word lists, or may be automatically generated, in which case the stop word lists may be prepared and customized for each query directly from the search results without any manual intervention. The data mining module 32 references the stop word lists to strip stop words from the search results associated with a respective engine, publication site or sequence site for which the particular stop word list being referred to has been customized, prior to determining the frequency of terms from the query that appear within each particular document. The list of terms occurring in each search result is then used to compute a proximity score to be used for clustering the search results.

Customized stop word lists may be automatically generated and tailored to individual or groups of generic, web-based search engines, as well as domain-relevant search engines, including, but not limited to publication sites and/or sequence sites, protein structure databases, pathway information databases and other specific databases. Such a feature eliminates the burden of having to manually prepare/edit these lists which may need to be changed as the generic, web-based search engines, publication sites, sequence sites and other sites change, e.g., as they are updated.

Still further, the data mining module may process the raw data, independently of the unsupervised clustering procedure and the single list generating procedure, to categorize the search results so that each search result is assigned to one of a predefined number of categories. A list of words may be provided for each of the predefined categories wherein the words in each list are particular to the respective category. The data mining module 32 compares the words in a particular list to a document to be characterized to determine whether the document is classified in that particular category. Upon completion of categorization, the search results are also displayed in a categorized format to the user interface.

Lists of words which are specific to each of the predefined categories may also be automatically generated, with the words in each list being particular to the respective category for which it is used. The automatic generation may be performed using a training set of search results, each having a known category. A list of words that are the most discriminatory among the predefined categories may then be identified from the training set, with regard to each category. Each word automatically selected for the generation of the word lists may be identified based on a function computed from a frequency of occurrence of the word in the particular category for which it is selected, relative to a frequency of occurrence of the word in the other existing categories.

The lists of words for each of the categories may be automatically selected by incremental training using the previously selected lists of words, categorizing new and old training documents using this list, and taking user feedback regarding the categorization of these documents.

Well known unsupervised clustering techniques, such as the group-average-linkage clustering algorithm ([A. K. Jain and R. C. Dubes, Algorithms for Clustering Data, 1998, Prentice Hall, Englewood Cliffs, New Jersey]) can be used to determine relative similarities between documents. A particular example of a group-average-linkage technique that may be employed uses the following algorithm for determining a proximity score Sᵢⱼ that defines relative distances between search results:

Sᵢⱼ=2×(½−N(Tᵢ,Tⱼ)/(N(T₁)+N(Tⱼ));

The proximity score Sᵢⱼ representing the distance between two search results “i” and “j”, where Tᵢ is a term in search result i; Tⱼ is a term in search result j; N(T₁,Tⱼ) is the number of co-occurring terms that search results i and j have in common; N(Tᵢ) is the number of terms found in search result i; and N(Tⱼ) is the number of terms in search result j. By normalizing the scores, identical search results (i.e., two search results having all terms in common) will have a proximity distance of zero (0), while completely orthogonal search results (i.e., having no terms in common) will have a proximity score of one (1). The hierarchical clustering procedure may be run until all the search results fall into one cluster. In order to view the results of the hierarchical clustering, a stop point can be set by the user to display the status of the results of the hierarchical clustering at any round or step intermediate of the processing, i.e., after beginning the clustering process, but before all search results have been subsumed into a single cluster. Thus, a stop point can be set for a pre-set number of clusters, or when the proximity scores become greater than or equal to some pre-defined value between zero and one. Combinations of stop points can be set, such that display of clusters occurs whenever the first stop point is reached.

The word “term” used above corresponds to a word in a search result (stop words may or may not have been removed from the search results). Stop words are list of words that occur very frequently in search results (such as common English words) and are deemed as insignificant in identifying similarities between search results. The use of this unsupervised clustering technique is also described in U.S. patent application Ser. No. 10/033/823 entitled “Domain Specific Knowledge-Based Metasearch System and Methods of Using” filed Dec. 19,2001, the disclosure of which is incorporated herein by reference.

Preprocessor 60 of data mining algorithm may also include a categorization module (not shown), which categorizes every search result into pre-defined, user-defined, or ontology-based categories. As an example, the set of rules defining the underlying ontology may be used to identify if a search result belongs to a particular category or not. The set of words occurring in the search result can also be used to train a classifier to identify discriminating words for each category and use these sets of discriminating words to classify search results into various categories.

Data mining module also includes a query handler element 64 for interaction with request broker 22, handling queries and search results based on selectable data mining algorithms, and monitoring or tracking of data mining query results.

Data mining Preprocessor 60 may contain commonly used nucleotide sequence algorithms such as FASTA and BLAST. FASTA and BLAST are approximate heuristic algorithms used to compute sub-optimal pair-wise similarity comparisons. Series of subsequence alignments are computed and combined to approximate a larger sequence alignment and a global similarity score (See .e.g., http://www-nbrf.georgetown.edu/pirwww/search/fasta.html and http://www.ncbi.nlm.nih.gov/BLAST/). The FASTA and BLAST algorithms may be internal to preprocessor 60 or provided by plug-ins 58.

Numerous sequence-based data mining algorithms are known and may be used with data mining module 32 as plug-ins. Exemplary gene discovery algorithms include Aat, http://genome.cs.mtu.edu/aat.html, Banbury Cross, http://igs-server.cnrs-mrs.fr/igs/banbury/, EcoParse, Fex, http://dot.imgen.bcm.tmc.edu:933 1/gene-finder/gf.html, Gap 3, GeneID, http://apolo.imim.es/geneid.html, GeneMark, http://genemark.biology.gatech.edu/GeneMark/, GeneModeler, GeneParser, http://beagle.colorado.edu/-eesnyder/GeneParser.html, GeneParser2, GeneParser3, Genie, http://www.fruitfly.org/seq_tools/genie.html, GenLang, http://www.cbil.upenn. edu/genlang/genlang home.html Genscan, http://ccr081 .mit.edu/GENSCAN.html, GenViewer, http://www.itba.mi.cnr.it/webgene/, Glimmer, http://www.csjhu.edu/labs/compbio/glimmer.html, Grail, http://compbio.ornl.gov/gallery.html, Grail 2, http://compbio.ornl.gov/gallery.html, Great, Hexon/Fgeneh, http://dot.imgen.bcm.tmc. edu:933 1/gene-finder/gf.html, Morgan, http://www.csjhu/labs/compbio/morgan.html, Mzef, http://www.cshl.org/genefinder/, ORFgene, http://www.itba.mi.cnr.it/webgene/, Procrustes, http://www-hto.usc.edu/software/procrustes/index.html, Sorfind, http://www.rabbithutch.com, Veil, http://www.csjhu.edu/labs/compbio/veil.html, Xgrail, http://www.hgmp.embnet.org/Registered/Option/xgrail.html, and Xpound.

Request broker 22 determines which parts of a user query are to be directed to keyword search module 26, structured query module 28, ontology mapping module 30 and data mining module 32, in addition to executing queries on remote machines. Request broker 22 may comprise an object request broker program configured to manage communication and data exchange between distributed program objects. Request broker 22 handles typical network programming tasks such as location, registration and activation of the various modules or program objects associated with the modules of system 24. Particularly, request broker 22 may include programming configured to carry out operations associated with lookup and instantiation of objects on remote machines, marshaling parameters from one application object to another, handling security issues across machine boundaries, retrieving and publishing data associated with other object request brokers, invoking methods on a remote object using static and dynamic method invocation, providing for automatic instantiation of objects that are not running, routing callback methods to appropriate objects, and the like.

Request broker 22 may be configured for object management according to Common Object Request Broker Architecture (CORBA) specifications, with the modules of system 24 operatively coupled or interfaced to request broker 22 via interface definition language (IDL) stubs. Request broker 22 may alternatively be configured according to Java Remote Method Invocation (RMI) technology. For “PC-centric” embodiments of system 24, request broker 22 may be configured according to COM/DCOM specifications.

Reuse module 34 handles user search sessions and stores user actions from search sessions in user data store 20. Storable user actions include user keyword queries, structured queries, ontology-based queries, data mining processes, and the corresponding search results from such queries and processes. User actions may be stored automatically or according to user request for storage of specific actions. Subsequent access to stored user actions in user data store 20 may be permission based, and users can assign one or more different access levels to the stored information to control access to the information and ensure that the information is shared only with authorized users.

The flexible automation module 38 includes programming that allows users to define scripts or standard operating procedures that may be used again during subsequent search queries or search sessions, and or which may be used by different users. Search scripts or procedures created by flexible automation module are stored in data store 20. The use of search scripts or procedures by multiple users may be permission-based, and users may assign different access levels to stored scripts and procedures to control subsequent access thereto by other users.

The front end of system 24 is provided by user interface module 36, which is configured to visually present the various features involved in search sessions to users in a manner that is easy for end-user scientists to understand and utilize. The user interface module may provide, for example, “pull-down” menus to provide for user selection of search features, creation of files, “help” menus for providing instructions to users, graphical user interface (GUI) icons upon which a user may “click” with a mouse to make a selection, text fields in which a user may enter alphanumeric character strings using a keyboard, or other conventional visual interface tools.

User interface module 36 provides for representation of database record entities, including search results and/or search requests, as first class objects that are directly manipulable via the user visual interface by conventional “click-and-drag”, “cntrl-drag”, “double-click”, “shift-click” or other conventional user interface operations. Database record entities are thus movable, copyable, viewable and storable in folders, and are movable or copyable between multiple folders, by standard operations associated with keyboard and mouse manipulation by users.

Programming (not shown) associated with user interface module 36 may also be provided to allow cross-linking or limited cross linking within entities. User clicking on a keyword in a search result folder can provide a list of all search results in the folder that include the selected keyword. For example, in a folder including a large query result, a user may click on the text representing an author name to bring up a list of all items in the query result that include the name of the selected author.

User interface module 36 is adaptive and may include programming configured to automatically recognize when a user is repeating a task associated with searching of data store 12. As shown, user interface module 36 includes a service component 66 that maintains a model of a user or group of users based on prior user behavior in a search session or from earlier search sessions. Another service component 68 monitors user actions and recognizes or seeks to recognize when a user is repeating a task. The repeat recognition service component 68 may utilize machine learning algorithms that learn to abstract from the details of user actions so as to learn when two or more sets of action are similar. For example, if a user repeatedly copies icons from one folder to another, the precise name of the icon may be abstractable from the file copying actions of the user. The repeat recognition component 68 may also utilize profiling of the amounts of time spent in various program routines of a program or the number of times that a program routine is carried out, in order to detect repetition of user actions. A user interface service component 70 is provided to take predictions from the user model service component 66 and repeat recognition service component 68 and manage interactions with the user. The user interface service component 70 may include a variety of functionalities, including suggesting possible repetitive actions to the user, presenting putative repetitions to the user, and allowing a user to modify a suggested repetitive task. In some embodiments, the adaptive aspects of user interface module 36 may be embodied in a separate program module.

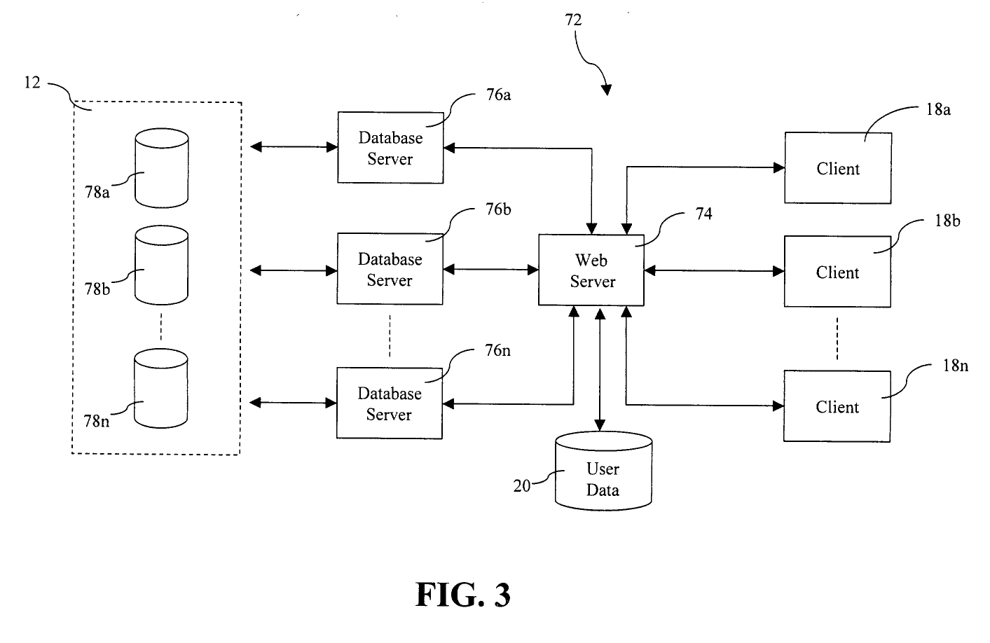

The system 24 is, in many embodiments, a distributed system wherein the various program modules of system 24 are located in or associated with multiple networked computers. FIG. 3 schematically shows a networked computer system 72 that may be used with the system 24, wherein like reference numbers are used to denote like parts. Network system 72, it should be kept in mind, represents only one of many possible computer network systems that may be used with the invention. The system 72 includes a plurality of client computers 18a, 18b, 18n, each of which may comprise a standard computer such as a minicomputer, a microcomputer, a UNIX® machine, mainframe machine, personal computer (PC) such as INTEL®, APPLE®, or SUN® based processing computer or clone thereof, or other appropriate computer. Client machines 18a, 18b, 18n may also include typical computer components (not shown), such as a motherboard, central processing unit (CPU), memory in the form of random access memory (RAM), hard disk drive, display adapter, other storage media such as diskette drive, CD-ROM, flash-ROM, tape drive, PCMCIA cards and/or other removable media, a monitor, keyboard, mouse and/or other user interface, a modem, network interface card (NIC), and/or other conventional input/output devices.

In many embodiments, client computers 18a, 18b, 18n comprise conventional desktop or “tower” machines, but can alternatively comprise portable or “laptop” computers, handheld personal digital assistants (PDAs), cellular phones capable of browsing Web pages, “dumb terminals” capable of browsing Web pages, internet terminals capable of browsing Web pages such as WEBTV®, or other Web browsing or network enabled devices. Each client computer 18a, 18b, 18n may comprise, loaded in its memory, an operating system (not shown) such as UNIX®, WINDOWS® 98, WINDOWS® ME, WINDOWS® 2000 or the like. Each client computer 18a, 18b, 18n may further have loaded in memory a Web Browser program (not shown) such as NETSCAPE NAVIGATOR®, INTERNET EXPLORER®, AOL®, or like browsing software for client computers.

The system 72 also comprises one or more web servers 74, only one of which is shown. Server 74 may be any standard data processing device or computer, including a minicomputer, a microcomputer, a UNIX® machine, a mainframe machine, a personal computer (PC) such as INTEL® based processing computer or clone thereof, an APPLE® computer or clone thereof or, a SUN® workstation, or other appropriate computer. Server 74 may include conventional computer components (not shown) such as a motherboard, central processing unit (CPU), random access memory (RAM), hard disk drive, display adapter, other storage media such as diskette drive, CD-ROM, flash-ROM, tape drive, PCMCIA cards and/or other removable media, a monitor, keyboard, mouse and/or other user interface means, a modem, network interface card (NIC), and/or other conventional input/output devices. Server 74 has stored in its memory a server operating system (not shown) such as UNIX®, WINDOWS® NT, NOVELL®, SOLARIS®, or other server operating system. Server 74 also has loaded in its memory web server software (also not shown) such as NETSCAPE, INTERNET INFORMATION SERVERTM (IIS), or other appropriate web server software loaded for handling HTTP (hypertext transfer protocol) or Web page requests.

System 72 also includes one or more database servers 76a, 76b, 76n, which may comprise computers or data processing devices of the type described for server 74, and include a motherboard, central processing unit (CPU), random access memory (RAM) and other system memory together with a stored server operating system therein, a monitor, keyboard, mouse and/or other user interface means, a modem, network interface card (NIC), and/or other conventional input/output devices.

Client computers 18a, 18b, 18n are operatively coupled to server 74 for communication with server 74 via the Internet (not shown) or other computer network using DSL (digital subscriber line), telephone connection with a modem and telephone line via an internet service provider (ISP), wireless connection, satellite connection, infrared connection, or other means for establishing a connection to the Internet. Server 74 may be connected to the Internet by a fast data connection such as T1, T3, multiple T1, multiple T3, or other data connection. Client computers 18a, 18b, 18n and server 74 may communicate via the Internet or other network connection using the TCP/IP (transfer control protocovinternet protocol) or other network communication protocol. Server 74 is likewise operatively coupled to database servers 76a, 76b, 76n for communication via the Internet. Database servers 76a, 76b, 76n in turn are operatively coupled to databases 78a, 78b, 78n in data store 12 for searching thereof in accordance with the invention. Databases 78a, 78b, 78n may comprises, for example, copies or partial copies of public and/or proprietary sequence databases, structure databases, scientific literature databases, or like databases as noted above.

The various software or program modules of system 24 may reside in the memory of various computers within the system 72 of FIG. 3. For example, in many embodiments, request broker 22, user interface module 36, flexible automation module 38, and reuse module 34 may be associated with the memory of server 74. In this regard, visual aspects of the user interface generated by module 32 may comprise HTML embedded entities that are executed by browser programming stored on client machines 18a, 18b, 18n. Data store 20 may be physically located in the memory of individual client machines 18a, 18b, 18n or maintained elsewhere. In some embodiments, reuse module 34, flexible automation module 38 and/or one or more aspects of user interface module 36 may, instead of operating as web-based applications, be downloaded to or otherwise loaded into the memory of client machines 18a, 18b, 18n.

Keyword search module 26, structured query module 28, ontology mapping module 30, and data mining module 32 may each be associated with client machines 18a-18n, server 74 and/or database servers 76a, 76b, 76n. Individual database servers may be dedicated to particular search functions, i.e., one database server exclusively carries out keyword searches in accordance with the keyword search module 26 stored therein, while another database server includes structured query module 28 exclusively carries out structured query searches, and so on. In other embodiments, each database server 76a, 76b, 76n may include each of the database search modules 26, 28, 30, 32 and may each carry out the various search functions provided by the invention. Use of multiple database servers may be managed according to traffic levels using load balancing considerations known in the art. Various other computer network system, and distributions of the software components of system 24 will suggest themselves to those skilled in the art and are also considered to be within the scope of this disclosure.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A data access and analysis system, comprising:
(a) a data source containing at least a partial copy of at least two public databases;
(b) at least one search program module operatively coupled to the data source and configured to carry out a search of said databases in said data source according to a user query;
(c) a data mining module operatively coupled to the data source and configured to provide for clustering of search results from said user query; and
(d) a user interface program module operatively coupled to said search program module and said data mining module, said user interface program module configured provide a visual interface for creating said user query and viewing said search results.

2. The system of claim 1, further comprising a reuse program module operatively coupled to said search program module, said data mining module and said user interface program module, said reuse module configured to store user action information in a user data source.

3. The system of claim 1, further comprising a request broker program element operatively coupled to said search program module, said data mining module and said user interface program module, said request broker program element configured to direct at least a portion of said user query to said search program module.

4. The system of claim 1, wherein said at least one search program module comprises a keyword search program module and a structured query search program module.

5. The system of claim 1, wherein said at least one search program module comprises an ontology mapping program module configured to search said data source according to annotation of a selectable ontology.

6. The system of claim 1, further comprising a flexible automation program module configured to allow users to define re-usable search scripts.

7. The system of claim 1, wherein said user interface module is configured to recognize repetitions of user tasks and provide predictions, based on said repetitions, to a user via said visual interface.

8. The system of claim 1, wherein said data mining module is further configured to identify search results according to a selected reference.

9. The system of claim 1, wherein said data mining module is further configured to form clusters of related search results according to an unsupervised clustering procedure.

10. The system of claim 9, wherein said data mining module is capable of preparing a single list of all search results retrieved independently of said unsupervised clustering procedure.

11. The system of claim 1, wherein said data mining module is further configured to assign a relevance score to said search results based upon a frequency of terms from said query that appear within each said search result.

12. The system of claim 9, wherein the unsupervised clustering procedure performed by said data mining module employs a group-average-linkage technique to determine relative distances between said search results.

13. The method of claim 12, wherein said group-average-linkage technique employs an algorithm for determining a proximity score that defines relative distances between said search results, said algorithm comprising
Sᵢⱼ=2×(1/2−N(Tᵢ,Tⱼ)/(N(Tᵢ)+N(Tⱼ))
wherein T₁ is a term in a search result I, Tⱼ is a term in a search result J, N(T₁,Tⱼ) is the number of co-occurring terms that said search results I and J have in common, N(Tᵢ) is the number of terms in search result I, and N(Tⱼ) is the number of terms in search result J.

14. A method for data access and data analysis, comprising
(a) providing a data store containing at least partial copies of at least two public databases;
(b) formulating a query by a user;
(c) submitting said query uniformly to each said database in said data store;
(d) fetching search results based on said query; and
(e) forming clusters of related said search results by a data mining module according to an unsupervised clustering procedure.

15. The method of claim 14, further comprising displaying said clusters of said related search results on a user interface.

16. The method of claim 14, further comprising storing said clusters of said related search results in a user data store.

17. The method of claim 16, further comprising storing at least one user action, associated with said submitting said query, in said user data store.

18. The method of claim 16, further comprising defining a reusable query script and storing said query script in said user data store.

19. The method of claim 16, further comprising identifying a repetitive user action and storing said repetitive user action in said user data store.

20. The method of claim 14, further comprising identifying search results, by said data mining module, according to a selected reference.

21. The method of claim 14, further comprising preparing, by said data mining module, a single list of all search results independently of said unsupervised clustering procedure.

22. The method of claim 14, further comprising assigning a relevance score, by said data mining module, to said search results based upon a frequency of terms from the query that appear within each said search result.

23. The method of claim 14, wherein said forming said clusters of said search results comprises employing, by said data mining module, a group-average-linkage technique to determine relative distances between said search results.

24. The method of claim 23, wherein said employing said group-average-linkage technique comprises employing an algorithm for determining a proximity score that defines relative distances between said search results, said algorithm comprising
Sᵢⱼ=2×(1/2−N(Tᵢ,Tⱼ)/(N(T₁)+N(Tⱼ))
wherein T₁ is a term in a search result I, Tⱼ is a term in a search result J, N(Tᵢ,Tⱼ) is the number of co-occurring terms that said search results I and J have in common, N(Tᵢ) is the number of terms in search result I, and N(Tⱼ) is the number of terms in search result J.

25. A data access and analysis system, comprising:
(a) data source means for providing at least a partial copy of each of a plurality of public databases;
(b) means for searching said data bases in said data source according to user queries;
(c) data mining means for clustering of documents resulting from said user queries; and
(d) user interface means for providing a visual interface for creating said user queries and viewing said resulting documents.

26. The system of claim 25, further comprising reuse program means for storing user action information associated with said user interface program means in a user data source.

27. The system of claim 25, further comprising request broker means for directing at least a portion of each said user queries to said searching means.

28. The system of claim 25, wherein said searching means comprises keyword search means for querying said data source according to at least one keyword.

29. The system of claim 25, wherein said searching means comprises structured query search means for extraction of structured information from said data source according to said user queries.

30. The system of claim 25, wherein said searching means comprises ontology mapping means for searching said data source according to annotation using a selectable ontology.

31. The system of claim 25, further comprising flexible automation means for defining re-usable user search scripts.

32. The system of claim 25, wherein said user interface means comprises means for recognizing repetitions of user tasks and providing predictions, based on said repetitions, to a user via said visual interface.

33. The system of claim 25, wherein said data mining means further comprises means for identifying said according to a selected reference document.

34. The system of claim 25, wherein said data mining means further comprises means for forming clusters of related said documents according to an unsupervised clustering procedure.

35. The system of claim 34, wherein said data mining means further comprises means for preparing a single list of all said documents retrieved independently of said unsupervised clustering procedure.

36. The system of claim 25, wherein said data mining means further comprises means for assigning a relevance score to said documents resulting from said user queries, based upon a frequency of terms from said query that appear within each said search result.

37. The system of claim 34, wherein said unsupervised clustering procedure employs a group-average-linkage technique to determine relative distances between said search results.

38. The system of claim 37, wherein said group-average-linkage technique employs an algorithm for determining a proximity score that defines relative distances between said search results, said algorithm comprising
Sᵢⱼ=2×(½−N(Tᵢ,Tⱼ)/(N(T₁)+N(Tⱼ))
wherein T₁ is a term in a search result I, Tⱼ is a term in a search result J, N(T₁,Tⱼ) is the number of co-occurring terms that said search results I and J have in common, N(Tᵢ) is the number of terms in search result I, and N(Tⱼ) is the number of terms in search result J.
